(19) United States
(12) Patent Application Publication
(10) Pub. No.: US 2007/0014113 A1
(43) Pub. Date: Jan. 18, 2007

(54) Light fixture

(75) Inventor: Jens Von Der Brelie, Frankfurt (DE)

Correspondence Address: THE FIRM OF KARL F ROSS, 5676 RIVERDALE AVENUE, PO BOX 900, RIVERDALE (BRONX), NY, 10471-0900, US

(73) Assignee: ERCO Leuchten GmbH

(21) Appl. No.: 11/439,888

(22) Filed: May 24, 2006

(30) Foreign Application Priority Data
May 24, 2005 (DE) 202005008322.4
Apr. 21, 2006 (DE) 102006019149.8

(51) Int. Cl. F21V 23/04

(52) U.S. Cl. 362/276

(57) ABSTRACT

A light fixture (10 is shown and described that has a light head (11) holding at least one light source (15) and an installation unit (12) with an installation memory (24) in which data about the light head is written/

The novelty is that the light head (11) has at least one light-head memory (18) separate from the installation memory (20), the data from the light-head memory being writable in the installation memory.

The invention relates to a light fixture according to the preamble of claim 1.

A light fixture according to the present patent application is any light fixture capable of illuminating or lighting a building surface, a part of a building surface, an object or an outside surface. At the same time the invention relates to light fixtures capable of backlighting a surface like a navigation light fixture or decor light fixture.

The invention is based on a light fixture as shown and described in post-published German patent applications DE 2005 009 228.4 and DE 10 2005 024 449.1 of applicant. Both of these patent applications are herewith completely included in the content of the present patent application, also for reference to individual or several features.

From the post-published patent applications a light fixture with a memory is known, in which information concerning the light fixture can be recorded. This may be for example explicit identifiers like a serial number, or data regarding the type of light head, for example the type or color of the light source or of plural light sources, regarding the electrical hookup, the production date, etc. A light head according to the present patent application is that part of the light fixture that contains at least one light source, in other words a lamp. Dependant on the type of light source used, the light head is typically also provided with reflectors, lenses, color filters, housing portions, light fixture bases, etc. A light head according to the present patent application can also be a standard, self-contained light fixture that can be connected to a controller of a light fixture control system by means of an installation unit.

The light head can have a housing that is separate from the installation unit or provided in a common shared housing together with the installation unit. An installation unit according to the present patent application is particularly but not exclusively an operating unit for the light head, for example an electrical power-supply circuit. The installation unit, however, can also be a separate device from the operating unit.

Preferably the installation unit can be connected with the signal line that connects the light fixture with a controller of a light fixture network. The controller can operate the light fixture transmitting control signals corresponding to the requests of the user or processing an electronic control program, for example switch on or off at certain times or, if differently colored light sources are provided, it can also make the color selection.

The data written in the installation memory concerning the light head can be taken into account when the light fixture is controlled. This is already noticeable during the installation of the light fixture network, for example when the controller can use the data concerning the light head in order to establish, by mapping comparison between for example a transmitted article number and a data base in the control, which kind or which type of light fixture is connected. When the light fixture is controlled, for example also light source-related data, like for example the maximum achievable light current or the exact color that can be generated by the light source, can be taken into account so that particularly exact color values can be achieved.

In certain applications it may be requested to replace an existing light fixture with a new light fixture. This can be necessary if the existing light fixture is defective or if a new light fixture with different characteristics is to be installed, for example if a downlight lighting a floor area is to be replaced by a spot light distribution with a wall-washer light.

Starting from this point the invention is based on the object to further develop a light fixture according to the preamble of claim 1 such that replacement of the light fixture is simplified.

The invention solves this object with the features of claim 1, particularly with those of the characterizing clause and is accordingly characterized in that to the light head is associated with at least one light-head memory that is separate from the installation memory and that contains light-head related data, the data can be read from the light-head memory and written into the installation memory.

The principle of the invention is basically that the light head has its own light-head memory. This light-head memory is a separate memory from the installation memory.

While the installation memory is preferably provided in an operating unit for the light head, the light-head memory is directly associated with the light head. Light-head-specific data is written in the light-head memory, particularly in the factory during production. This way, after the light fixture is produced, it contains for example data regarding the product number of the light head, the type of light source used, its color, if necessary also data regarding the reflectors used, etc.

Afterward the light head can be connected to an installation unit having an installation memory, either in the factory, at the client's, or during installation at the application site. The installation unit is for example the operating unit for the light head.

As a result of a connection between the light head and the installation unit, for example by an electric plug connection, in particular by a cable, the data in the light-head memory can be read and transferred to the installation memory. The installation memory thus knows which light head is connected to it.

The data now transferred to the installation memory can be transferred to the controller of the light fixture network by a signal line. The controller can then use the received light-head-related data for controlling the light fixture, if necessary, also during the installation process.

If only a part of the light head is defective and a complete replacement of the light head is necessary, or if the existing light head is to be replaced by a modified light head with different light-technical characteristics, the light head can be removed without problems from the installation unit and a new light head can be connected to the installation unit. When the connection between the new light head and the remaining installation unit is established, the light-head memory of the new light head can be read as well and the data can be transferred to the installation memory. Henceforth, the controller can access the light-head-related data of the new light head again.

With the light fixture according to the invention a particularly easy installation of the replacement light head or of a new light head with different light-technical characteristics is possible, without the whole light fixture having to be replaced.

It is enough to replace the actual light head. The installation unit can remain in place. Thus, the effort necessary for replacing the light head is distinctly reduced.

At the same time the controller is supplied with new light-head-related data in a very elegant manner. If necessary, a new installation can be avoided, since the installation unit remains in its original application site and thus the controller can memorize the positions of the installation units. The new light-head-related data therefore can be simply transmitted to the controller without great effort.

The light fixture according to the invention also reduces the effort necessary for storing parts of the light fixtures and for the installation of the light fixture. According to the invention it is possible to revert to standardized installation units that are produced completely independently from the light heads and can each be provided with an installation memory. In addition to the light-head-related data the installation memory can also contain installation unit related data, for example an unique identifier for the installation unit.

According to an advantageous embodiment of the invention the installation unit can be connected to the controller of a control system for several light fixtures through a signal line.

The data written in the installation memory can be transmitted to the controller, in particular over the signal line. Thus, a particularly elegant reading of the installation memory and furnishing of light-head related data to the controller can be carried out. As soon as the controller has received the light-head-related data, the controller can use this data for controlling the light fixtures, before or even before during the installation routine of the light fixtures.

According to an advantageous embodiment of the invention the data written in the installation memory can be taken into account when the light fixture is controlled. Thus the installation unit might be provided with a adjustment unit that adjusts the control commands received by the controller in accordance with the light-head-related data. As far as the possibility of correcting control signals is concerned reference is made to the post-published patent applications in order to avoid repetition.

A reading of the data from the light-head memory and a writing of the data into the installation memory preferably occurs during or after a connection between the light head and the installation unit is established. Such a connection can for example be established by an electrical line, in particular a plug connection. A reading of the light-head memory can for example be carried out as soon as the installation unit, that is in particular the operating unit for the light head has been supplied with operating voltage. A transmission of the light-head-related data from the light-head memory to the installation memory thereby can occur over data lines or over existing power supply lines, for example over corresponding power-line communication signals. Finally also a contact-free reading of the light-head memory from the installation memory, for example via electromagnetic waves can be carried out.

A reading of the data contained in the light-head memory can also be carried out after a control command is received that is sent from the controller to the installation unit.

According to an advantageous embodiment of the invention the installation unit is an operating unit for the light head. In particular the installation unit is an electrical power-supply circuit for the light head. Thus, it is possible to use standard operating units. This only requires a minor modification of the memory of the operating unit that has to be capable of receiving the light-head-related data from the light-head memory accordingly to the invention.

According to an advantageous embodiment of the invention a connection between the light head and the installation unit by electrical lines can be removeably established. In the case of the installations unit being the operating unit for the light head, the light head and the installation unit are connected to each other by power supply lines. The operating unit ensures that the light source or the light source at the light head is supplied with the necessary operating voltage at the right moment. The existing power supply lines can be used for transmitting the light-head-related data from the light-head memory to the installation memory. In this case these data signals can be modulated on the power supply lines.

Alternatively, data lines separate to the existing power supply lines that allow a transmission of data from the light-head memory to the installation memory can exist between the light head and the installation unit.

Finally also a wireless connection between the installation memory and the light-head memory can be provided that allows for example activation of the light-head memory by means of electromagnetic waves.

The light fixture according to the invention has several light heads according to an advantageous embodiment of the invention that can be connected to a shared installation unit. A single installation unit with a shared installation memory thus can store data from several light heads. As the different light heads are preferably provided with own light head memories, it is particularly advantageous if the installation memory can store the data from the plurality of light head memories. Thus all the data regarding the plurality of light heads that the installation memory has received from the plurality of light-head memories can be integrally or at least centrally transmitted to the controller of the network.

In a particular advantageous embodiment of the invention the light head is composed of several elements. The light head can for example be composed of a reflector, a light source, a cover glass, a housing part, a light fixture base, etc. The plurality of elements of a light head have their own light-head memories. Thus a reflector memory can be associated with the reflector that contains data regarding the type of reflector. For example, the reflector memory might contain the data that a spot reflector is used.

The light source can have its own light source memory that is for example arranged in a light fixture base for the light source. The light-source memory can contain data regarding the kind of light source to be stored in the light-fixture base.

Finally a part of the light head, for example a support for a cover glass can also contain its own cover-glass memory. It can contain data regarding the kind of cover glass, for example clear or diffusely dispersive cover glass, or regarding whether a colored cover glass or a color filter are used.

The individual memories, as for example the reflector memory, the light fixture base memory and the cover-glass memory can transmit their data to the installation memory. The installation memory can either itself collect the data received and refer to this data when the light source is controlled. In this situation an adjustment unit mentioned before could use this data.

Alternatively the installation memory could transfer the data received from the individual memories of the light head elements to the light fixture network, so that the controller can then use this data or take it into account when the light fixtures are controlled.

Further advantages of the invention result from the not cited subclaims as well as from the following description of several exemplary embodiments illustrated in the figures. Therein:

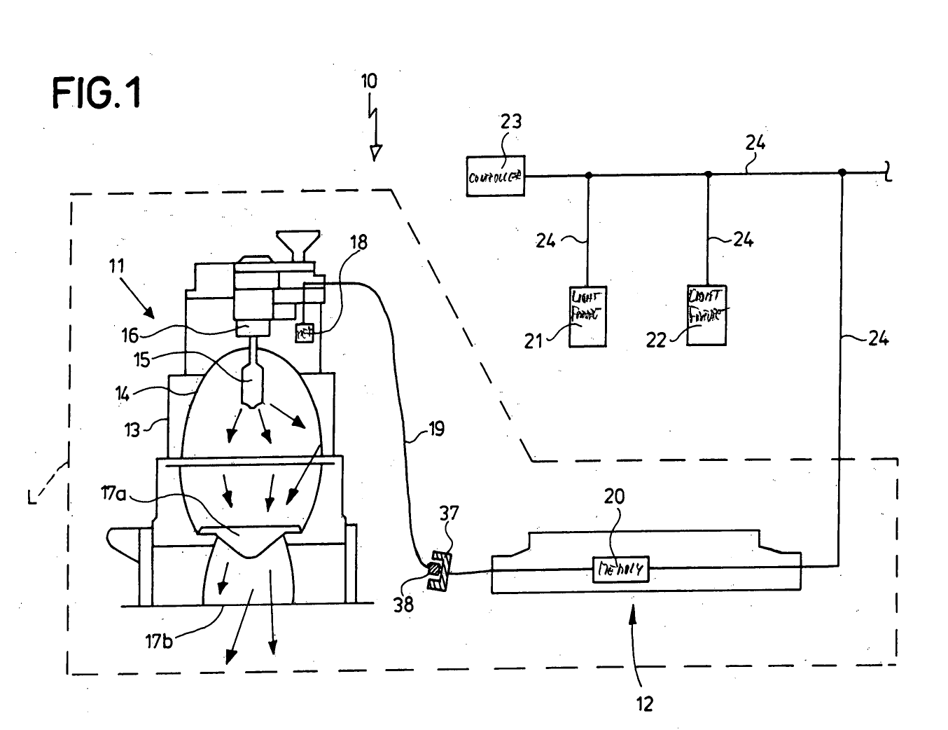

FIG. 1 is a schematic overview, partially similar to a block diagram, of an embodiment of a light fixture according to the invention in a lateral view with a light head and an installation unit as well as a part of the network;

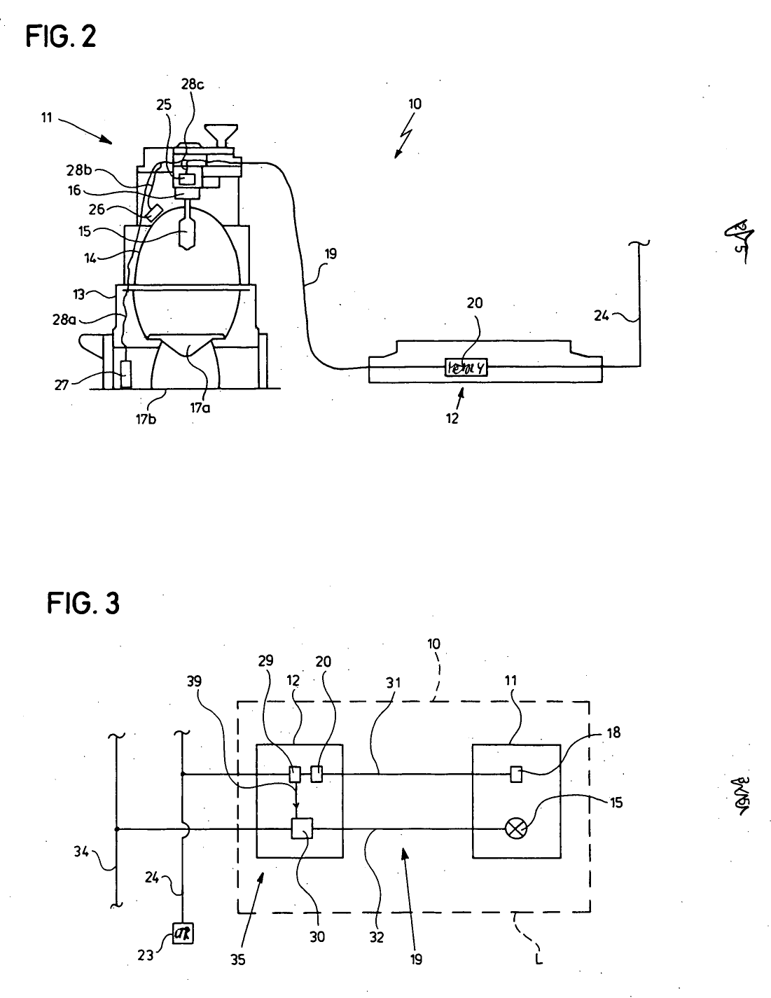

FIG. 2 is a second embodiment of a light fixture according to the invention in an illustration similar to FIG. 1, wherein part of the network is left out;

FIG. 3 is a schematic block diagram of a third embodiment of a light fixture according to the invention;

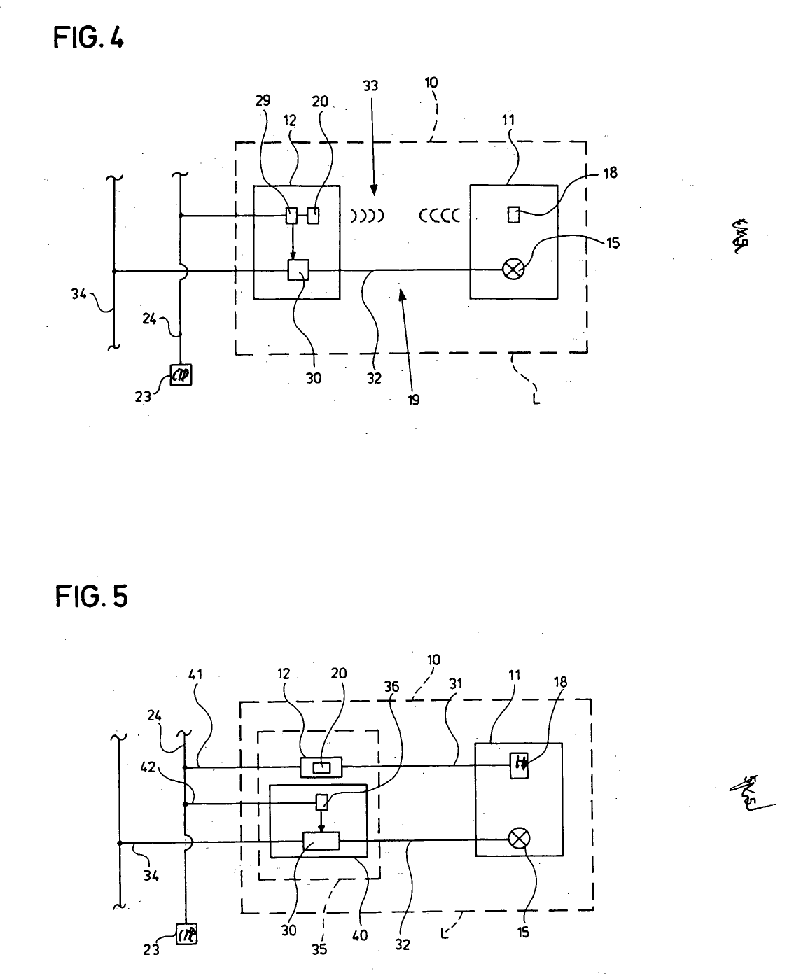

FIG. 4 is a fourth embodiment in an illustration similar to FIG. 3; and

FIG. 5 is a fifth embodiment of a light fixture according to the invention.

The light fixture as a whole according to the invention is indicated with 10 in the figures and is to be described in detail in the following. It should be noted that for reasons of clarity similar parts or elements, or parts or elements with comparable functions are indicated with the same reference signs even in different embodiments, sometimes with lower-case letters added.

FIG. 1 shows a light fixture 10 according to the invention with a light head 11 and an installation unit 12 in a schematic local sectional view. The surrounding dotted line L indicates that the light head 10 [translators note: should be 11] together with the installation unit 12 are referred to as a light fixture according to the invention.

The light head 11 comprises all the assemblies of a light fixture providing light-technical characteristics, that is a housing 13, a reflector 14, a light source 15, also referred to as a lamp, and a light fixture base 16. In the light path, only schematically indicated with the shown arrows, are provided for example diffuser elements 17a or 17b influencing the light transmission, which can also be lens elements, clearly or diffusely dispersing cover glasses, color filters, etc.

The light head 11 thus can be produced and constructed as a generic light head.

The installation unit 12 is basically formed according to as a standard operating unit, for example as an electrical power-supply circuit. The installation unit 12 can thus contain a transformer, a dimmer and/or other electrical or electronic components that are arranged between the light head 11 and the actual network established by a signal line 24.

The light fixture 10 is connected to a schematically shown control unit 23 by a signal line 24. The controller can send out a plurality of control commands through the signal line 24, which reach the installation unit 12. Other light fixtures, too, as for example the light fixtures 21 and 22 shown, can be connected to the network. Thus, the controller 23 can control numerous light fixtures like a control center. The signal line, for example, can transmit control signals according to the DALI-protocol.

The light head 11 is connected to the installation unit 12 by a connecting line 19. The connecting line 19 initially serves in a standard manner to transmit the operating voltage necessary for the operation of the light source 15. Therefore, in the embodiment according to FIG. 1 the installation unit 12, ergo the operating unit, can particularly transmit the necessary and required operating voltage according to the control signals received by the controller 23.

In FIG. 1 the connection of the installation unit 12 to the power supply line supplying the installation unit 12 with operating voltage is not shown for reasons of clarity. FIG. 1 shows only the signal-technical connection between the light head 11, the installation unit 12 and the controller 23 in the form of the connecting line 19 and the signal line 24.

An installation memory 20 is provided at the installation unit 12 that may contain light-head-related data. In a light fixture described in the post-published patent application the installation memory 20 after manufacture of the whole light fixture 10 already contains data regarding the connected light head 11. Thus, the installation memory 20 can contain data regarding the product number of the light head 11, the number and type of the light sources 15 and, if necessary, also a specific identifier of the light fixture 10. The data contained in the memory 20 can be transmitted to the controller 23 by the signal line 24. This data can be used or taken into account when the light fixture 10 is controlled.

According to the invention the light head 11 of the embodiment in FIG. 1 is provided with the separate light-head memory 18. In the light-head memory 18 are stored light-head-related data, for example data regarding the number and type of light source 15, regarding the type of reflector 14, regarding the number and type of the diffuser or lens elements 17a and 17b, etc. In addition, the memory 18 can also include an explicit identifier in form of a serial number and/or an article number.

The installation unit 12 and the light head 11 can be produced independently from each other. A connection of these two parts 11, 12 does not have to be carried out directly after the production, but can also be carried out at the application site, on the construction site. Only when the light head 11 and the installation unit 12 are connected to each other by the connection 19 is the light-head-related data contained in the light-head memory 18 transmitted to the installation memory 20 of the installation unit 12. The installation memory 20 stores this data and, if necessary, can transmit it to the controller 23 by the signal line 24. Alternately an adjustment unit can be provided in the installation unit 12 that takes the light-head-related data into account when it receives control commands from the controller 23. The latter is particularly advantageous if the data contained in the light-head memory 18 and transmitted to the installation memory 20 contain data regarding specific characteristics of the light source, as for example maximal light current or exact light color, age of the light source, etc.

The connection 19 in the embodiment according to FIG. 1 is established by a cable that both contains lines for transmitting the operating voltage from the installation unit 12 to the light head 11 and for transmitting data from the light-head memory 18 to the installation memory 20. For example, the connecting line 19 can be a four-conductor or five-conductor cable. The connecting line 19 therefore can contain for example three standard conductors for the transmission of operating voltage, such as for instance power, neutral, and ground, as well as two additional conductors in order to provide a twin-wire signal line between the light head 11 and the installation unit 12. Alternatively the connecting line 19 can also contain a different number of conductors. It is also possible that data transfer for the transmission of the data to be read from the light-head memory 18 to the installation memory 20 occurs by signals that can be modulated on the existing power supply line of the connection 19. Finally the connecting line 19 can also be composed of two separate cable connections, a first cable connection serving to supply the light head 11 with operating voltage and a second connecting cable serving to provide a signal-technical connection.

The connection 19 between the light head 11 and the installation unit 12 is removable. A socket 37 at the side of the installation unit and a plug 38 at the side of the light head are only shown in a very schematic manner by which the removability of the connection is to be emphasized.

If the light head 11 is defective and is to be replaced by a new light head 11 or if it is necessary to connect a new light head 11 with modified light-technical characteristics to the installation unit 12, the removable connection 37, 38 can be disconnected and a new connection established. The newly connected light head 11 has its own light-head memory 18 with data contained therein that contain data regarding this new light head. This new data can be again transmitted to the installation memory 20 after the connection 37, 38 has been established. The installation memory 20 can transfer/transmit this data to the controller 23.

This way, a simple replacement of the light head 11 is possible in the light fixture according to the invention while the installation unit 12 can remain installed at the application site. Thus an additional installation step is avoided in the case of a replacement of the light head 11. Since the controller 23 can memorize the position and particularly the identity of the installation unit 12, for the subsequent controlling of the new light head 11 a transmission of light-head-related data from the memory 18 to the memory 20 and a subsequent transmission of the data to the controller 23 are sufficient. No new position data about the newly connected light head 11 has to be transmitted to the controller since the corresponding position data is already available to the installation unit 12 that remained at the application site.

In an alternative embodiment according to FIG. 2 the light head 11 is composed of a plurality of elements that have their own memories.

In FIG. 2 a base memory 25 for the light source 15 is provided, approximately in the area of the base 16 that contains data regarding for example the type of the connected light source 15. The reflector 14 has its own associated reflector memory 26 that contains data regarding the kind of reflector, for example the size of the reflector or an indication whether a spot or wall washer reflector is used.

Finally, a cover glass memory 27 that contains data regarding what type of diffuser or lens elements are arranged at the light head 11 is assigned to a diffuser or lens element 17a or 17b or alternatively to the light head housing 13. The cover glass memory 27 can also contain data regarding, for example, whether a certain color filter or the like is provided.

The three memories 25, 26, 27 are also referred to as light-head memories according to the present patent application. The three memories can be connected to the memory 20 of the installation unit by individual connector lines 28a, 28b, and 28c to the shared connecting line 19. Alternatively separate lines can lead to the installation memory 20 from the three single memories 25, 26, 27.

It should be noted that all the memories in the light head 11 and in the installation unit 12 described so far and further to be described can for example be memories that can be read electronically, for example like an EPROM memory. Also, every other possibility to retrievably store data is suitable, for example as well RFID circuits, memories that can be read optically or electromagnetically, magnet memories, etc.

If a light fixture 10 according to the invention modularly out of single elements 13, 14, 15, 17a, 17b according to the embodiment of FIG. 2, during manufacture of the light head any composition of the single assemblies or components of the light head 11 is possible, thus for example any type of reflector 14, light fixture socket 16 or light source 15 and diffuser or lens or color filter elements 17a, 17b that individually were provided with separate associated memories 25, 26, 27 before the assembly of the light head 11.

This modularly constructed light-head construction 11 can, if necessary, be recognized as the light head 11 with particular light-technical characteristics only at the application site by the installation unit 12 or only by the controller 23 subsequent to transmission of all the light-head-related data to the controller 23, and after recognition of the light-technical characteristics of this light fixture 10 can be controlled in an optimal manner.

FIG. 3 shows with the help of an illustration similar to a block diagram that the light head 11 can contain a light fixture 15 and a light-head memory 18, this illustration being strongly related to the embodiment of FIG. 1. The installation unit 12 can be an operating unit 35 and contain for example a transformer 30 connecting the light source 15 by a power supply line 32 to the power lines 34. The light-head memory 18 is connected to the memory 20 of the installation unit by a data line 31 that is separate from the power supply line 32. It should be noted that both lines 31, 32 can be in form of twin wires or multiconductor wires.

The installation unit 12 is connected to the signal line 24. In the installation unit 12 for example an adjustment unit 29 can be provided that adjusts the control signals received from the controller 23 considering the data written in the installation memory 20 received by the light-head memory 18 regarding the light source characteristics. The adjusting function should be indicated with the arrow 39. The adjustment unit 29 influences the operating behavior of the transformer 30. For example the adjustment unit 29 can switch the transformer 30 on or off or control certain operational characteristics.

In the embodiment according to FIG. 3 the light-head-related data read from the light-head memory 18 that are contained in the installation memory 20 can be also transferred to the control unit 23 by the adjustment or control device 29 and the signal line 24. In this case the control unit 23 can already take into account the characteristics of the light head 11 when the light fixture 10 is installed, so that the adjustment device 29 does not have to carry out an adjustment function in this case, but only a control function.

FIG. 4 shows an embodiment in an illustration comparable to FIG. 3, the separate data line 31 being eliminated and replaced by a radio link 33. The installation memory 20 can read the light-head-related data contained in the light-head memory 18 by electromagnetic waves or a different wireless transmission connection. A reading can for example take place if the light head 11 is so close to the installation unit 12 that a minimum distance is not respected.

FIG. 5 shows an alternate embodiment of a light fixture 10 according to the invention, the operating unit 35 of which is divided into two parts 12 and 40. The operating unit 35 has a basically standard operating unit indicated with 40, as well as an installation unit 12 separated thereof.

The standard operating unit 40 is connected in the normal manner to the light source 15 of the light head 11 by a power supply line 32. The installation unit 12 that has an installation memory 20 is connected to the light-head memory 18 by a separate data line 31 and allows a reading of the light-head-related data. The installation unit 12 is connected to the network line 24 by a separate connecting line 41 and can transfer data received from the light-head memory 18 to the controller 23. The installation unit 12, however, in this embodiment is as well associated with the standard operating unit 40, for example attached to the standard operating unit 40. The standard operating unit 40 has a separate connection 42 to the signal line 24, by which a DALI connection unit 36 can be addressed that in its turn carries out a control function, for example regarding a transformer 30 of the operating unit 40.

The light fixture 10 according to the invention can also have an installation unit 12 to which plural light heads 11 are connected, which is not shown in the figures. While any of the plurality of light heads contains its own light-head memory, the installation unit 12 with its installation memory 20 can receive all the light-head-related data from the different light heads and, as required, either directly transmit the data to the controller 23 of the light fixture network or take it into account when carrying out an adjustment function when the light fixtures are controlled.

The light fixture according to the invention allows recognition of a light head or of parts 15, 14, 17a, 17b of a light head 11 by the installation unit 12, for example by an operating unit. If necessary, the installation unit 12 itself can be equipped with the intelligence necessary to recognize the parts of the light head and to assemble them like software. Alternatively the installation unit 12 can also have the role of transmitting the light-head-related data to the controller so that the controller 23 recognizes the light head 11 or the parts of the light head 11 and thus can carry out an optimized controlling.

The light fixture according to the invention allows a light fixture management inside of the light fixture. A replacement of a light head 11 is possible without associated operating units having to be replaced if the light head 11 and the operating unit 12 have their own memory and if a transmission of data from the light-head memory to the memory associated with the operating unit is possible.

A reading of the light-head memory 18 or a transmission of the data to the installation memory 20 can be carried out when the light head 11 is connected to the installation unit 12 or alternatively only when the installation unit 12 is attached to the signal line 24 and connected to the controller 23.

1. A light fixture (10) having a light head (11) holding at least one light source (15) and an installation unit (12) with an installation memory (24) in which data about the light head is written, characterized in that the light head (11) has at least one light-head memory (18) separate from the installation memory (20), the data from the light-head memory being writable in the installation memory.

2. The light fixture according to claim 1, characterized in that the installation unit (12) is connectable via a signal line (24) with a controller (23) of a control system for a plurality of light fixtures (10, 21, 22).

3. The light fixture according to claim 2, characterized in that the data written in the installation memory (20) is transmittable to the controller (23).

4. The light fixture according to claim 1, characterized in that the data written in the installation memory (29) is taken into account when operating the light fixture (10).

5. The light fixture according to claim 1, characterized in that data is read and written during or after making a connection (19) between the light head (11) and the installation unit (12).

6. The light fixture according to claim 1, characterized in that the installation unit (12) is an operating unit, in particular an electronic power-supply circuit, for the light head (11) (FIG. 1).

7. The light fixture according to claim 6, characterized in that the installation memory (20) is provided in the operating unit (FIG. 1)

8. The light fixture according to claim 1, characterized in that the installation unit (12) is separate from the operating unit (40) for the light head (11) (FIG. 5).

9. The light fixture according to claim 8, characterized in that the installation unit (12) has a signal-line connection (41) separate from a signal-line connection (42) of the operating unit (40) (FIG. 5).

10. The light fixture according to claim 1, characterized in that a connection (19) between the light head (11) and the installation unit (12) is releasably made via electrical lines (19, 31, 32).

11. The light fixture according to claim 10, characterized in that the electrical lines (31) are constituted as data lines (FIG. 3).

12. The light fixture according to claim 1, characterized in that the light head (11) is connected with the installation unit (12) via voltage-supply lines (32).

13. The light fixture according to claim 11, characterized in that the data lines (31) are separate from the power-supply lines (32).

14. The light fixture according to claim 11, characterized in that the existing voltage-supply lines are used as data lines.

15. The light fixture according to claim 1, characterized in that the a signal connection is provided between the light head (11) and the installation unit (12) for reading the light-head memory (18) via electromagnetic waves (FIG. 4).

16. The light fixture according to claim 1, characterized in that a plurality of light heads (11) are connected with one installation unit (12).

17. The light fixture according to claim 16, characterized in that the plurality of light heads each have their own light-head memories.

18. The light fixture according to claim 1, characterized in that the light head (11) is formed of several elements, such as a reflector 914), light source (15), cover glass (17a, 17b) and the like.

19. The light fixture according to claim 18, characterized in that several elements (14, 15, 17a, 17b) of a light head (11) each have their own light-head memory (25, 26, 17).

20. The light fixture according to claim 19, characterized in that the installation memory (29) can receive the data from several light-head memories (25, 26, 27).

21. The light fixture according to claim 20, characterized in that data is transmitted through the data line (24) according to the DALI protocol.

22. The light fixture according to claim 1, characterized in that the light-head-related data includes data about the type and kind of light head (11) or about the type and kind of a part (14, 15, 17a, 17b) of a light head (11).

23. The light fixture according to claim 22, characterized in that the light-head-related data includes an identification number for the light head (11), inn particular a product number of the light head.

24. The light fixture according to claim 1, characterized in that the light-head-related data includes an individualized identifier for the light head (11) to make it individually identifiable.
